(19) United States
(12) Patent Application Publication
(10) Pub. No.: US 2011/0043541 A1
(43) Pub. Date: Feb. 24, 2011

(54) FAULT DETECTION IN ELECTROLUMINESCENT DISPLAYS

(76) Inventor: Ronald S. Cok, Rochester, NY (US)

Correspondence Address: MORGAN LEWIS & BOCKIUS LLP, 1111 PENNSYLVANIA AVENUE NW, WASHINGTON, DC, 20004, US

(21) Appl. No.: 12/544,294

(22) Filed: Aug. 20, 2009

(51) Int. Cl. G09G 5/10; G09G 3/30; H01J 9/24

(52) U.S. Cl. 345/690; 345/76; 445/3

(57) ABSTRACT

Detecting faults in driving circuits within a display device is disclosed. The display device has an array of pixels formed over a substrate in a display area, each pixel having a driving circuit and an associated communication circuit, the communication circuits together forming a multi-pixel serial shift register. The multi-pixel serial shift register is used to shift desired pixel luminance values from a display controller through the multi-pixel serial shift register to corresponding driving circuits for driving the pixels with driven electrical signals to emit light corresponding to the desired pixel luminance values, and sensing electrical signals corresponding to the driven electrical signals with a sensing circuit. Further the sensed electrical signals are shifted by the multi-pixel serial shift register to the display controller and faults are detected in the driving circuits by analyzing the sensed electrical signals.

### FIELD OF THE INVENTION

The present invention relates to fault detection in display devices having a substrate with distributed, independent chiplets for controlling a pixel array and for communicating with the pixel array.

### BACKGROUND OF THE INVENTION

Flat-panel display devices are widely used in conjunction with computing devices, in portable devices, and for entertainment devices such as televisions. Such displays typically employ a plurality of pixels distributed over a substrate to display images. Each pixel incorporates several, differently colored light-emitting elements commonly referred to as sub-pixels, typically emitting red, green, and blue light, to represent each image element. As used herein, pixels and sub-pixels are not distinguished and refer to a single light-emitting element. A variety of flat-panel display technologies are known, for example plasma displays, liquid crystal displays, and light-emitting diode (LED) displays.

Light emitting diodes (LEDs) incorporating thin films of light-emitting materials forming light-emitting elements have many advantages in a flat-panel display device and are useful in optical systems. U.S. Pat. No. 6,384,529 to Tang et al. shows an organic LED (OLED) color display that includes an array of organic LED light-emitting elements. Alternatively, inorganic materials can be employed and can include phosphorescent crystals or quantum dots in a polycrystalline semiconductor matrix. Other thin films of organic or inorganic materials can also be employed to control charge injection, transport, or blocking to the light-emitting-thin-film materials, and are known in the art. The materials are placed upon a substrate between electrodes, with an encapsulating cover layer or plate. Light is emitted from a pixel when current passes through the light-emitting material. The frequency of the emitted light is dependent on the nature of the material used. In such a display, light can be emitted through the substrate (a bottom emitter) or through the encapsulating cover (a top emitter), or both. However, the efficiency of organic materials in particular, decreases as the organic materials are used.

LED devices can include a patterned light-emissive layer wherein different materials are employed in the pattern to emit different colors of light when current passes through the materials. Alternatively, one can employ a single emissive layer, for example, a white-light emitter, together with color filters for forming a full-color display, as is taught in U.S. Pat. No. 6,987,355 by Cok. It is also known to employ a white sub-pixel that does not include a color filter, for example, as taught in U.S. Pat. No. 6,919,681 by Cok et al. A design employing an unpatterned white emitter has been proposed together with a four-color pixel including red, green, and blue color filters and sub-pixels and an unfiltered white sub-pixel to improve the efficiency of the device (see, e.g. U.S. Pat. No. 7,230,594 to Miller, et al).

Two different methods for controlling the pixels in a flat-panel display device are generally known: active-matrix control and passive-matrix control. In a passive-matrix device, the substrate does not include any active electronic elements (e.g. transistors). An array of row electrodes and an orthogonal array of column electrodes in a separate layer are formed over the substrate; the overlapping intersections between the row and column electrodes form the electrodes of a light-emitting diode. External driver integrated circuits (chips) then sequentially supply current to each row (or column) while the orthogonal column (or row) supplies a suitable voltage to illuminate each light-emitting diode in the row (or column). Therefore, a passive-matrix design employs 2n connections to produce n² separately controllable light-emitting elements. However, a passive-matrix drive device is limited in the number of rows (or columns) that can be included in the device since the sequential nature of the row (or column) driving creates flicker. If too many rows are included, the flicker can become perceptible. Moreover, the currents necessary to drive an entire row (or column) in a display can be problematic since the power required for the non-imaging pre-charge and discharge steps of PM driving become dominant as the area of the PM display grows. These problems limit the physical size of a passive-matrix display.

In an active-matrix device, active control elements are formed of thin films of semiconductor material, for example amorphous or poly-crystalline silicon, coated over the flat-panel substrate. Typically, each sub-pixel is controlled by one control element and each control element includes at least one transistor. For example, in a simple active-matrix organic light-emitting (OLED) display, each control element includes two transistors (a select transistor and a power transistor) and one capacitor for storing a charge specifying the luminance of the sub-pixel. Each light-emitting element typically employs an independent control electrode and an electrode electrically connected in common. Control of the light-emitting elements is typically provided through a data signal line, a select signal line, a power connection and a ground connection. Active-matrix elements are not necessarily limited to displays and can be distributed over a substrate and employed in other applications requiring spatially distributed control. The same number of external control lines (except for power and ground) can be employed in an active-matrix device as in a passive-matrix device. However, in an active-matrix device, each light-emitting element has a separate driving connection from a control circuit and is active even when not selected for data deposition so that flicker is eliminated.

One common, prior-art method of forming active-matrix control elements typically deposits thin films of semiconductor materials, such as silicon, onto a glass substrate and then forms the semiconductor materials into transistors and capacitors through photolithographic processes. The thin-film silicon can be either amorphous or polycrystalline. Thin-film transistors (TFTs) made from amorphous or polycrystalline silicon are relatively large and have lower performance compared to conventional transistors made in crystalline silicon wafers. Moreover, such thin-film devices typically exhibit local or large-area non-uniformity across the glass substrate that results in non-uniformity in the electrical performance and visual appearance of displays employing such materials. In such active-matrix designs, each light-emitting element requires a separate connection to a driving circuit. Employing an alternative control technique, Matsumura et al describe crystalline silicon substrates used for driving LCD displays in U.S. Patent Application Publication No. 2006/0055864. Matsumura et al describe a method for selectively transferring and affixing pixel-control devices made from first semiconductor substrates onto a second planar display substrate. Wiring interconnections within the pixel-control device and connections from busses and control electrodes to the pixel-control device are shown. With such a control technique, it is important that all of the crystalline silicon substrates be properly transferred and affixed on the second planar display substrate.

Image data is typically distributed to active-matrix controlled displays through data and select control lines connected to the driving circuits of each pixel. These lines form a grid of control wires over the substrate that reduces the available substrate area for light emission. Data representing the performance of each pixel circuit can be collected and used to improve the device performance, for example as described in U.S. Pat. No. 6,995,519. The wiring and circuitry requirements of this design, however, can further reduce the substrate area available for light emission.

It is known to employ test structures within integrated circuits and displays to test the performance of displays and to detect faults in circuits. These faults can prevent an integrated circuit, or the device into which an integrated circuit is designed. For example, U.S. Pat. No. 6,995,519, noted above, discloses electrically testing the drive transistors in an OLED display. U.S. Pat. No. 6,720,942 describes an addressable image-display pixel with a light-emitter, a photo-sensor optically coupled to the light emitter, and a feedback readout circuit. U.S. Pat. No. 6,028,441 describes self-testing routines in an LED display device by monitoring current use by the LEDs. U.S. Pat. No. 5,369,357 describes an optically operated test structure for a CCD imager for testing the modulation transfer function for the CCD. The wiring and circuitry requirements of these designs can reduce the substrate area available for light emission.

Since a conventional passive-matrix display design is limited in size and number of light-emitting elements, an active-matrix design using TFTs has lower electrical performance and complex substrates as well as significant wiring requirements, and device testing and fault detection is important for manufacturing yield and display lifetime,

There is a need for improved control, fault-detecting test structures, and improved methods of manufacturing display devices

### SUMMARY OF THE INVENTION

In accordance with the present invention, there is provided a method of detecting faults in driving circuits within a display device having an array of pixels formed over a substrate in a display area, each pixel having a driving circuit and an associated communication circuit, the communication circuits together forming a multi-pixel serial shift register, comprising:

(a) using the multi-pixel serial shift register to shift desired pixel luminance values from a display controller through the multi-pixel serial shift register to corresponding driving circuits for driving the pixels with driven electrical signals to emit light corresponding to the desired pixel luminance values;

(b) sensing electrical signals corresponding to the driven electrical signals with a sensing circuit;

(c) shifting the sensed electrical signals with the multi-pixel serial shift register to the display controller; and

(d) detecting faults in the driving circuits by analyzing the sensed electrical signals.

The present invention has the advantage that, by providing a display device with embedded chiplet control and fault detection, improved performance, improved routing, and manufacturing yields are improved. A serial shift register for communication provides a simple and flexible way to control the display device.

### BRIEF DESCRIPTION OF THE DRAWINGS

FIG. 1 is a schematic of a display device according to an embodiment of the present invention;

FIG. 2 is a schematic of pixel circuitry shown in FIG. 1 according to an embodiment of the present invention;

FIG. 3 is a cross section of the display device with chiplet circuits according to an embodiment of the present invention;

FIG. 4A is a partial schematic of the sensing circuit shown in FIG. 1 according to an embodiment of the present invention;

FIG. 4B is a partial schematic of the sensing circuit shown in FIG. 1 having a light-responsive circuit according to an embodiment of the present invention;

FIG. 5 is an operational flow diagram according to an embodiment of the present invention; and

FIG. 6 is a manufacturing flow diagram according to an embodiment of the present invention.

Because the various layers and elements in the drawings have greatly different sizes, the drawings are not to scale.

### DETAILED DESCRIPTION OF THE INVENTION

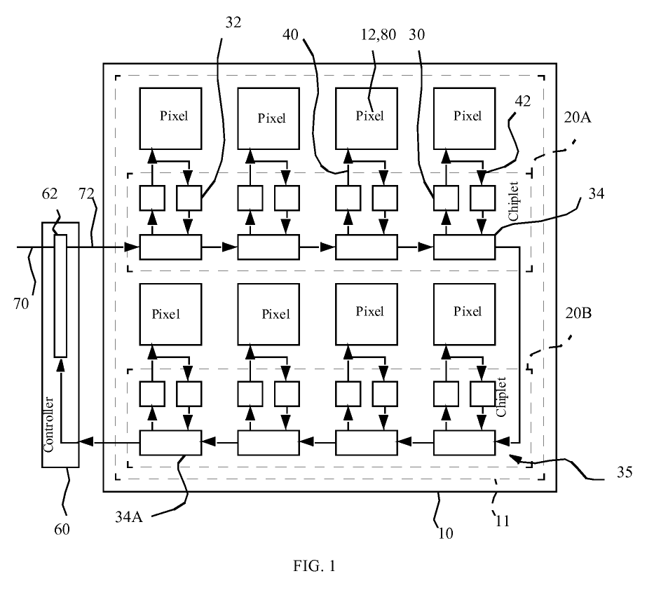

Referring to FIGS. 1 and 3, in one embodiment of the present invention, a display device includes a display substrate 10 having a display area 11. A plurality of pixels 80 are formed over the display substrate 10 in the display area 11, each pixel including a first electrode 12, one or more layers of light-emitting material 14 formed over the first electrode 12, and a second electrode 16 formed over the one or more layers of light-emitting material 14, the light-emitting material emitting light 14 in response to a current passed through the light-emitting material 14 by the first and the second electrodes 12, 16 with a driven electrical signal. A driving circuit 30 is located in the display area 11 for each driven electrical signal, the driving circuit 30 providing the driven electrical signal 40 corresponding to a desired pixel luminance value 72 to the first or second electrode 12, 16 of the pixel 80, the driven electrical signal 40 producing a current passed through the light-emitting material 14 to emit light. A sensing circuit 32 is located in the display area 11 for each driven electrical signal 40 (that can correspond to each pixel 80), the sensing circuit 32 sensing a sensed electrical signal 42 corresponding to the driven electrical signal 40 or to the light emitted by each pixel 80. A communication circuit 34 is located in the display area 11 for each pixel 80. The communication circuits 34 together form a multi-pixel serial shift register 35 that communicates the desired luminance values 72 from a display controller 60 to the driving circuits 30 for each pixel 80 and that also communicates the sensed electrical signals 42 for each pixel 80 to the display controller 60. In an embodiment of the present invention, the display controller 60 can be part of the display device. The display controller 60 can be responsive to an image signal 70.

Referring also to FIG. 3, a chiplet 20 having a separate chiplet substrate 28 is adhered to the display substrate 10 and buried with adhesive layer 18. The chiplet 20 includes circuitry 22. First electrodes 12 are electrically connected to connection pads 24 formed on the chiplet 20. Light-emitting material 14 is located over the first electrodes 12 and second electrodes 16 formed over the light-emitting material 14. The light-emitting material 14 can include multiple layers of light-emitting material as well as various charge-control layers as are known in the organic and inorganic light-emitting diode art. The electrodes 12, 16 and light-emitting material 14 form a light-emitting diode 15.

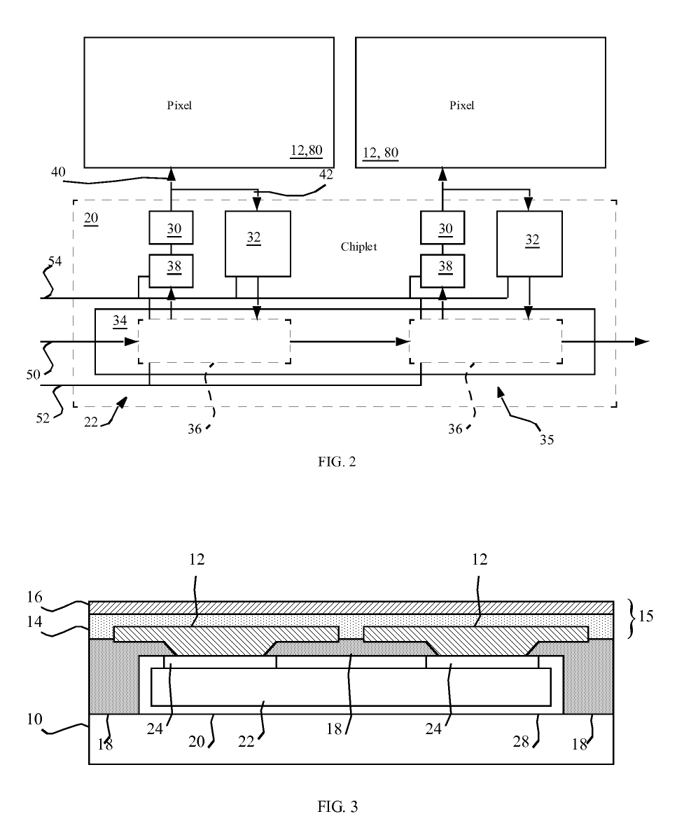

In one embodiment of the present invention, the driving, sensing, and communication circuits 30, 32, 34 are thin-film transistor circuits formed on the display substrate 10 in the display area 11 using conventional photolithographic techniques. However, because of the size and performance of such thin-film electronic components, such a design can significantly reduce the available area on the display substrate 10 for light emission or wiring. In an alternative embodiment of the present invention, the driving, sensing, and communication circuits 30, 32, 34 are chiplets 20 having circuitry 22 formed on chiplet substrates 28 separate from the display substrate 10 and located over the display substrate 10 in the display area 11. Chiplets 20 (e.g. 20A, 20B in FIG. 1) can be formed in higher-performance crystalline silicon that enables high-speed, small-size circuits in the chiplets and within the display area 11. For example, referring to FIGS. 1 and 2 in one embodiment of the present invention, each chiplet communication circuit 34 can include a serial shift register 36 that is serially connected to the serial shift register 36 of a neighboring chiplet communication circuit 34 to form a multi-chiplet, multi-pixel serial shift register 35, and at least one of the chiplet communication circuits 34A (FIG. 1) is connected to the display controller 60. In an active-matrix display embodiment, the driven electrical signals 40 can directly correspond to a single pixel 80 and directly drive a pixel electrode (e.g. first electrode 12). In an alternative, passive-matrix embodiment, each driven electrical signals 40 can drive a column (or row) of electrodes.

Referring to FIG. 2, each circuit associated with a pixel 80 or driven electrical signal 40 can include a storage element 38 for storing the desired luminance value for the pixel 80. The storage element 38 is connected to the driving circuit 30 to drive the driven electrical signal 40 with the desired luminance value. The corresponding storage element 38 can be associated with the sensing circuit 32 (not shown in FIG. 2) if desired. The storage elements 38 can be controlled with control signal 54 to store the desired luminance value. Desired luminance values can be shifted through the multi-pixel serial shift register 35 with data signal 50 under the control of control signal 52, for example a clock signal. The data signal 50 can be an electrical charge or voltage and the storage elements 38 and registers 34 can be analog storage elements. The signal and storage elements and registers can also be digital. Analog storage and shifting elements are known in the prior art, for example in CCD and CMOS image sensors. Likewise, the sensed electrical signals can be analog and represented by an electrical charge or voltage.

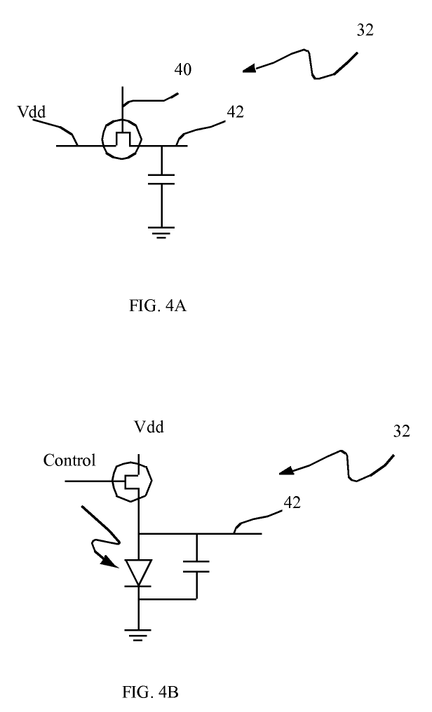

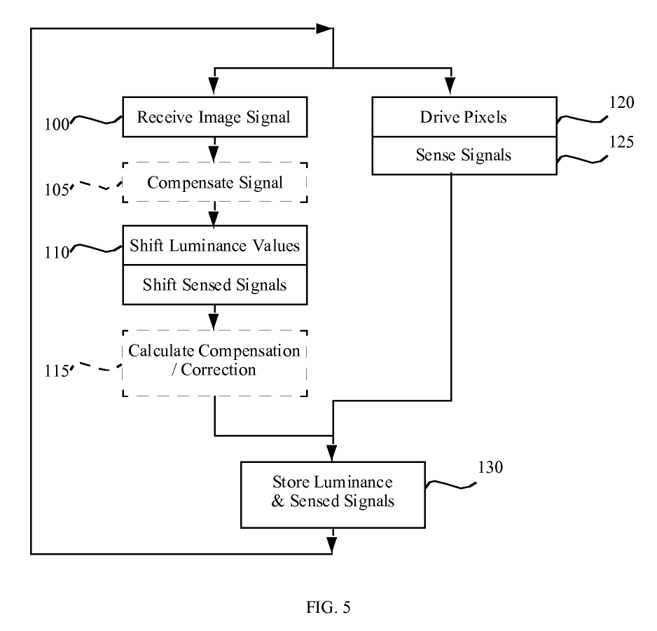

The sensed electrical signal 42 corresponds to the performance of each pixel 80 with which it is associated. In one embodiment of the present invention, the sensed electrical signal 42 is taken from the driven electrical signal 40 (e.g. by controlling a transistor as shown in FIG. 4A or by transferring a voltage through a transistor). When shifted out of the display into the display controller 60, the sensed electrical signal 42 can be compared to the expected driven electrical signal derived from the desired pixel luminance signal to determine if the circuitry in the display device is functioning correctly. In this case, the sensed electrical signal 42 can be connected to the first or second electrode 12, 16 and can correspond to a voltage provided on the first or second electrode 12, 16 or to a current provided through the light-emitting material 14 by the first and second electrodes 12, 16. If the sensed electrical signal 42 is not the correct signal, the circuitry 22 or chiplet 20 can be repaired or replaced.

In another embodiment of the present invention, the sensing circuit 32 can include a light-responsive circuit responsive to the light emitted by the light-emitting material 14 that produces the sensed electrical signal 42 corresponding to the light emitted by the light-emitting material 14 (e.g. as shown in FIG. 4B with a photo-sensitive diode that can discharge a capacitor that is initially charged in response to a control signal). In this case, the sensed electrical signal 42 corresponds to the driven electrical signal 40 indirectly through the light emission of the light-emitting material 14 controlled by the driven electrical signal 40. Within this disclosure, a sensed electrical signal 42 is considered to correspond to the driven electrical signal 40 when the sensed electrical signal 42 is formed by sensing the light output of a light emitter driven by the driven electrical signal 40. When shifted out of the display into a display controller 60, the sensed electrical signal 42 can be compared to the expected luminance value to determine if the light-emitting element in the display device is functioning correctly. If not, the driven electrical signal 40 can be compensated for the light-emitting element performance to achieve the desired pixel luminance by including a compensation circuit 62 in the display controller 60 that compensates the desired pixel luminance values by analyzing the sensed electrical values. In such an embodiment, the light-responsive circuit can also be responsive to ambient light to produce a sensed electrical signal responsive to ambient light.

Referring to FIGS. 1 and 5, the display device of the present invention can be operated by receiving (Step 100) an image signal with the display controller 60. The display controller 60 can compensate (Step 105) the image signal if compensation parameters are available. The luminance values, either compensated or not compensated, of the image signal are shifted (Step 110) into the display area 11 under the control of the display controller 60 through the communications circuit 34 and the multi-pixel serial shift register 35, for example through chiplet circuitry 22. At the same time, any sensed electrical signals 42 are also shifted out through the communication circuit 34 and the multi-pixel serial shift register 35 to the display controller 60. The display controller 60 can calculate (Step 115) compensation parameters using the sensed electrical signals. The luminance values can be stored 130 and then used to drive (Step 120) the pixels and sensed (Step 125) electrical signals. The embodiment of FIG. 5 can shift in new luminance values through the multi-pixel serial shift register 35 at the same time as the previously shifted luminance values are employed to drive the pixels and to sense the circuit or light-emitter performance by storing the display pixels in storage elements 38 local to the pixel. The pixel luminance value shifting, the storage element storing, the sensing circuit sensing, and the sensed electrical signal shifting or compensation calculation can form a multi-stage process. When the process begins, the driven pixels and sensed electrical signals are not valid; nor can any compensation be performed since there is no valid data with which to drive the pixels. After the first luminance data is shifted into the display, the driven pixels become valid as well as the sensed electrical signals. After the valid sensed electrical signals are shifted out, the compensation circuit 62 can compute valid compensation parameters and input image signals can be compensated. The sensing circuit 32 can sense either the electrical performance of the driving circuit 30 (e.g. voltage or current) or the light output by the light-emitting materials 14. If the light output is sensed, the compensation circuit 62 in the controller 60 can analyze the sensed electrical signals 42 to determine the light output by the pixels 80 and compensating the luminance values to maintain the desired luminance. In a further embodiment of the present invention, the compensation circuit 62 can employ the sensed electrical signals 42 to determine faults in the driving or communication circuits in the display. Compensation circuit 62 can include digital circuits known in the art, for example including stored programs, central processing units, state machines, digital logic, and memories.

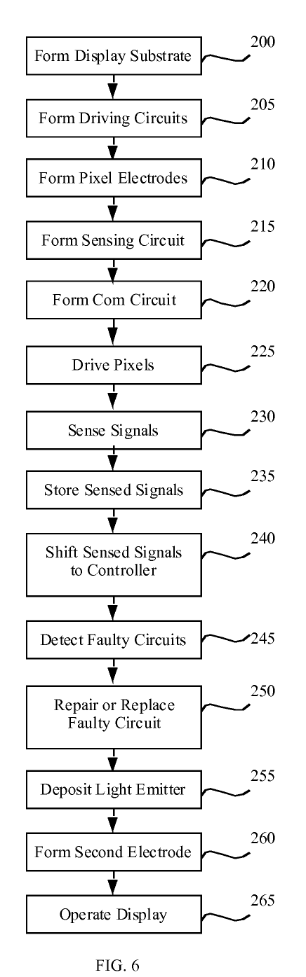

The present invention can also be employed to improve the manufacturing yields of displays by testing the circuitry prior to the deposition of the light-emitting materials. In one embodiment of the present invention and as illustrated in FIGS. 1 and 6, the display substrate 10 having display area 11 is formed (Step 200), driving circuits 30 are formed (Step 205) on the display substrate 10, and a plurality of pixel electrodes 12 are formed (Step 210). Each first electrode 12 can be associated with the pixel 80. Sensing circuits 32 are also formed (Step 215). The communication circuit 34 in the display area 11 for each driven electrical signal 40 (e.g. for a pixel 80) is formed (Step 220), the communication circuits 34 forming a multi-pixel serial shift register 35 for shifting desired luminance values to each first electrode 12 and shifting sensed electrical signals 42 to the display controller 60. The pixel electrodes 12 are driven (Step 225) with driven electrical signals 40 corresponding to the shifted desired luminance values for each pixel 80. The sensing circuits 32 sense (Step 230) the sensed electrical signal 42 corresponding to the driven electrical signal 40 and stores (Step 235) the sensed electrical signal 42. The communication circuit 34 for each pixel 80 communicates (Step 240) the sensed electrical signal 42 through the multi-pixel serial shift register 35 to the display controller 60. The sensed electrical signals 42 are then analyzed to detect (Step 245) faulty driving, sensing, or communication circuits 30, 32, 34, wiring, or electrical connections. Any detected faulty driving, sensing, communication circuits 30, 32, 34, wiring, or electrical connections are repaired or replaced (Step 250). The light-emitting materials 14 can then be deposited (Step 255), the second electrode 16 formed (Step 260) over the light-emitting materials 14 and the device operated (Step 265) as described above.

Furthermore, a method of making a display device can further include providing the display controller 60 with the compensation circuit 62 and driving the light-emitting material 14 with a current corresponding to the driven electrical signal 40 to emit light, sensing the light emitted by the light-emitting material 14 to form the sensed electrical signal 42 corresponding to the driven electrical signal 40, communicating the sensed electrical signal 42 through the multi-pixel serial shift register 35 to the display controller 60, analyzing the sensed electrical signal 42 to determine pixel luminance compensation values; and storing the compensation values in the compensation circuit 62 to compensate the desired pixel luminance values for the sensed light emitted by the light-emitting material 14 as described with reference to FIG. 5.

Chiplets 20 can have a single row or multiple rows of connection pads 24 along a relatively long side of the chiplet longer than a relatively shorter neighboring side. Chiplets can be connected to an external controller through a buss or through multiple busses. The buss can be a serial, parallel, or point-to-point buss and can be digital or analog. A buss is connected to the chiplets to provide signals, such as power, ground, data, or select signals. More than one buss separately connected to one or more controllers can be employed.

In operation, a controller receives and processes an information signal according to the needs of the display device and transmits the processed signal and control information through the multi-pixel serial shift register to each chiplet in the device. The processed signal includes luminance information for each light-emitting pixel element. The luminance information can be stored in an analog or digital storage element corresponding to each light-emitting pixel element. The chiplets then activate the pixels to which they are connected.

Additional busses can supply a variety of signals, including timing (e.g. clock) signals, data signals, select signals, power connections, or ground connections. The signals can be analog or digital, for example digital addresses or data values. Analog data values can be supplied as charge or voltage. The storage registers can be digital (for example including flip-flops) or analog (for example including capacitors for storing charge).

In one embodiment of the present invention, the display device is an electroluminescent display such as an OLED display. In another embodiment of the present invention, the communication circuit further includes a second serial shift register having storage elements for shifting values corresponding to the desired pixel luminance from a controller to the driving circuit corresponding to each pixel. In this case, the serial shift registers can be used alternately. The values can be charges and the storage elements can be capacitors. Charge storage and shifting are known in the CCD art. The driving circuit for each pixel can drive the pixel with an electrical signal corresponding to the charge stored in the first or second serial shift register. Each pixel can be an active-matrix pixel element. Alternatively, circuitry, for example chiplet circuitry, can provide passive-matrix control of pixel groups. The displays can be top-emitter or bottom emitter.

The controller can be implemented as a chiplet and affixed to the substrate. The controller can be located on the periphery of the substrate, or can be external to the substrate and include a conventional integrated circuit.

According to various embodiments of the present invention, the chiplets can be constructed in a variety of ways, for example with one or two rows of connection pads along a long dimension of a chiplet. Interconnection busses and wires can be formed from various materials and use various methods for deposition on the device substrate. For example, interconnection busses and wires can be metal, either evaporated or sputtered, for example aluminum or aluminum alloys. Alternatively, the interconnection busses and wires can be made of cured conductive inks or metal oxides. In one cost-advantaged embodiment, the interconnection busses and wires are formed in a single layer.

The present invention is particularly useful for multi-pixel device embodiments employing a large device substrate, e.g. glass, plastic, or foil, with a plurality of chiplets arranged in a regular arrangement over the device substrate. Each chiplet can control a plurality of pixels formed over the device display substrate according to the circuitry in the chiplet and in response to control signals. Individual pixel groups or multiple pixel groups can be located on tiled elements, which can be assembled to form the entire display.

According to the present invention, chiplets provide distributed pixel control elements over a substrate. A chiplet is a relatively small integrated circuit compared to the device substrate and includes a circuit including wires, connection pads, passive components such as resistors or capacitors, or active components such as transistors or diodes, formed on an independent substrate. Chiplets are manufactured separately from the display substrate and then applied to the display substrate. The chiplets are preferably manufactured using silicon or silicon on insulator (SOI) wafers using known processes for fabricating semiconductor devices. Each chiplet is then separated prior to attachment to the device substrate. The crystalline base of each chiplet can therefore be considered a substrate separate from the device substrate and over which the chiplet circuitry is disposed. The plurality of chiplets therefore has a corresponding plurality of substrates separate from the device substrate and each other. In particular, the independent substrates are separate from the substrate on which the pixels are formed and the areas of the independent, chiplet substrates, taken together, are smaller than the device substrate. Chiplets can have a crystalline substrate to provide higher performance active components than are found in, for example, thin-film amorphous or polycrystalline silicon devices. Chiplets can have a thickness preferably of 100 μm or less, and more preferably 20 μm or less. This facilitates formation of the adhesive and planarization material over the chiplet that can then be applied using conventional spin-coating techniques. According to one embodiment of the present invention, chiplets formed on crystalline silicon substrates are arranged in a geometric array and adhered to a device substrate with adhesion or planarization materials. Connection pads on the surface of the chiplets are employed to connect each chiplet to signal wires, power busses and electrodes to drive pixels. Chiplets can control at least four pixels.

Since the chiplets are formed in a semiconductor substrate, the circuitry of the chiplet can be formed using modern lithography tools. With such tools, feature sizes of 0.5 microns or less are readily available. For example, modern semiconductor fabrication lines can achieve line widths of 90 nm or 45 nm and can be employed in making the chiplets of the present invention. The chiplet, however, also requires connection pads for making electrical connection to the wiring layer provided over the chiplets once assembled onto the display substrate. The connection pads must be sized based on the feature size of the lithography tools used on the display substrate (for example 5 μm) and the alignment of the chiplets to the wiring layer (for example ±5 um). Therefore, the connection pads can be, for example, 15 um wide with 5 um spaces between the pads. This shows that the pads will generally be significantly larger than the transistor circuitry formed in the chiplet.

The pads can generally be formed in a metallization layer on the chiplet over the transistors. It is desirable to make the chiplet with as small a surface area as possible to enable a low manufacturing cost.

By employing chiplets with independent substrates (e.g. including crystalline silicon) having circuitry with higher performance than circuits formed directly on the substrate (e.g. amorphous or polycrystalline silicon), a device with higher performance is provided. Since crystalline silicon has not only higher performance but much smaller active elements (e.g. transistors), the circuitry size is much reduced. A useful chiplet can also be formed using micro-electro-mechanical (MEMS) structures, for example as described in “A novel use of MEMs switches in driving AMOLED”, by Yoon, Lee, Yang, and Jang, Digest of Technical Papers of the Society for Information Display, 2008, 3.4, p. 13.

The device substrate can include glass and the wiring layers made of evaporated or sputtered metal or metal alloys, e.g. aluminum or silver, formed over a planarization layer (e.g. resin) patterned with photolithographic techniques known in the art. The chiplets can be formed using conventional techniques well established in the integrated circuit industry.

The present invention can be employed in devices having a multi-pixel infrastructure. In particular, the present invention can be practiced with LED devices, either organic or inorganic, and is particularly useful in information-display devices. In a preferred embodiment, the present invention is employed in a flat-panel OLED device composed of small-molecule or polymeric OLEDs as disclosed in, but not limited to U.S. Pat. No. 4,769,292 to Tang et al., and U.S. Pat. No. 5,061,569 to VanSlyke et al. Inorganic devices, for example, employing quantum dots formed in a polycrystalline semiconductor matrix (for example, as taught in U.S. Patent Application Publication No. 2007/0057263 by Kahen), and employing organic or inorganic charge-control layers, or hybrid organic/inorganic devices can be employed. Many combinations and variations of organic or inorganic light-emitting displays can be used to fabricate such a device, including active-matrix displays having either a top- or bottom-emitter architecture.

The invention has been described in detail with particular reference to certain preferred embodiments thereof, but it should be understood that variations and modifications can be effected within the spirit and scope of the invention.

### PARTS LIST

10 display substrate
11 display area
12 first electrode
12 pixel electrode
14 light-emitting material
15 light-emitting diode
16 second electrode
18 adhesive layer
20, 20A, 20B chiplet
circuitry
connection pad
28 chiplet substrate
driving circuit
sensing circuit
34, 34A communication circuit
multi-pixel serial shift register
serial shift register
storage element
40 driven electrical signal
sensed electrical signal
50 data signal
52 control signal
54 control signal
60 display controller
62 compensation circuit
70 image signal
72 desired luminance value signal
80 pixel
100 receive image signal step
105 compensate signal step
110 shift luminance and sensed signals step
115 calculate compensation/correction step
120 drive pixels step
125 sense signals step
130 store luminance and sensed signals step
form display substrate step
form driving circuits step
210 form pixel electrodes step
215 form sensing circuit step
220 form communications circuit step
225 drive pixels step
230 sense signals step
store sensed signals step
shift sensed signals to controller
detect faulty circuits step
repair or replace faulty circuit step
255 provide light emitter step
260 provide second electrode step
operate display step

1. An electroluminescent display device for determining faults in the display driving circuit, comprising:
(a) a display controller providing desired pixel luminance values and a display substrate having a display area;
(b) a plurality of pixels formed over the display substrate in the display area, each pixel including a first electrode, one or more layers of light-emitting material formed over the first electrode, and a second electrode formed over the one or more layers of light-emitting material, the light-emitting material emitting light in response to a current passed through the light-emitting material by the first and the second electrodes with a plurality of driven electrical signal;
(c) a driving circuit located in the display area for each driven electrical signal, the driving circuit providing the driven electrical signal corresponding to each desired pixel luminance value to the first or second electrode of corresponding pixels, the driven electrical signal producing a current passing through the light-emitting material causing it to emit light;
(d) a sensing circuit located in the display area for each driven electrical signal, the sensing circuit sensing a sensed electrical signal corresponding to the driven electrical signal or to the light emitted by each pixel; and
(e) a communication circuit located in the display area for each driven electrical signal, two or more communication circuits together forming a multi-pixel serial shift register that receives desired luminance values from the display controller and provides the desired luminance values to corresponding driving circuits for each pixel and that receives the sensed electrical signals from the sensing circuit for each driven electrical signal and communicates the sensed electrical signals for each driven electrical signal to the display controller; and
(f) means responsive to the sensed electrical signals in the display controller for determining faults in the performance of the driving circuit.

2. The display device of claim 1, wherein the driving, sensing, and communication circuits are thin-film transistor circuits formed on the display substrate in the display area.

3. The display device of claim 1, further including chiplets having substrates separate from the display substrate located over the display substrate in the display area, each chiplet being associated with a one or more pixels and wherein the driving, sensing, and communication circuits are formed in the corresponding chiplets.

4. The display device of claim 3, wherein at least one serial shift register is formed in each chiplet.

5. The display device of claim 1, further comprising storage elements for storing each of the desired pixel luminance values or for storing each of the sensed electrical signals.

6. The display device of claim 1, wherein the desired luminance values are represented as electrical charges or voltages.

7. The display device of claim 1, wherein the sensed electrical signals are represented as electrical charges or voltages.

8. The display device of claim 1, wherein the sensing circuit is connected to the corresponding first or second electrode.

9. The display device of claim 8, wherein the sensed electrical signal corresponds to a voltage provided on the corresponding first or second electrode or to a current provided through the light-emitting layer by the first and second electrodes.

10. The display device of claim 1, wherein the sensing circuit includes a light-responsive circuit responsive to the light emitted by the light-emitting material that produces a sensed electrical signal corresponding to the light emitted by the light-emitting material.

11. The display device of claim 10, wherein the light-responsive circuit is responsive to ambient light to produce a sensed electrical signal responsive to ambient light.

12. The display device of claim 10, further comprising a compensation circuit in the controller that compensates the desired pixel luminance values for the sensed light emitted by the light-emitting material by analyzing the sensed electrical values.

13. A method of detecting faults in driving circuits within a display device having an array of pixels formed over a substrate in a display area, each pixel having a driving circuit and an associated communication circuit, the communication circuits together forming a multi-pixel serial shift register, comprising:
(a) using the multi-pixel serial shift register to shift desired pixel luminance values from a display controller through the multi-pixel serial shift register to corresponding driving circuits for driving the pixels with driven electrical signals to emit light corresponding to the desired pixel luminance values;
(b) sensing electrical signals corresponding to the driven electrical signals with a sensing circuit;
(c) shifting the sensed electrical signals with the multi-pixel serial shift register to the display controller; and
(d) detecting faults in the driving circuits by analyzing the sensed electrical signals.

14. The method of claim 13, wherein the sensing circuit directly senses the driven electrical signals to form the sensed electrical signals.

15. The method of claim 13, wherein the sensing circuit senses light emitted by the pixels to form the sensed electrical signals.

16. The method of claim 15, further comprising analyzing the sensed electrical signals to determine the light output by the pixels and compensating the luminance values to maintain the desired luminance.

17. A method of making a display device, comprising:
(a) forming a display substrate having a display area including a plurality of pixel electrodes in the display area;
(b) forming a communication circuit in the display area for each pixel electrode, the communication circuits forming a multi-pixel serial shift register for shifting desired luminance values to each pixel electrode;
(c) forming driving circuits in the display area for driving the pixel electrodes with driven electrical signals corresponding to the shifted desired luminance values for pixels associated with the pixel electrode;
(d) forming a sensing circuit located in the display area for each pixel, the sensing circuit sensing a sensed electrical signal corresponding to the driven electrical signal;
(e) providing a display controller for communicating desired luminance values to the driving circuits through the multi-pixel serial shift register and receiving the sensed electrical signal through the multi-pixel serial shift register to the controller;
(f) driving the pixel electrode with the driven electrical signal, sensing an electrical signal corresponding to the driven electrical signal, and communicating the sensed electrical signal to the controller through the multi-pixel serial shift register; and
(g) analyzing the sensed electrical signals, detecting a faulty driving, sensing, or communication circuit, and repairing or replacing the faulty driving, sensing or communication circuit.

18. The method of making a display device of claim 17, further comprising forming one or more layers of light-emitting material over the pixel electrodes and then forming one or more second electrodes over the one or more layers of light-emitting material.

19. The method of making a display device of claim 18, further comprising:
(a) providing the controller with a compensation circuit;
(b) driving the light-emitting material with a current corresponding to the driven electrical signal to emit light, sensing the light emitted by the light-emitting material to form a sensed electrical signal corresponding to the driven electrical signal, communicating the sensed electrical signal through the multi-pixel serial shift register to a controller, analyzing the sensed electrical signal to determine pixel luminance compensation values; and
(c) storing the compensation values in the compensation circuit to compensate the desired pixel luminance values for the sensed light emitted by the light-emitting material.
